(19) United States
(12) Patent Application Publication
(10) Pub. No.: US 2026/0149083 A1
(43) Pub. Date: May 28, 2026

(54) COOLING MEMBER AND BATTERY PACK INCLUDING THE SAME

(71) Applicants: HYUNDAI MOTOR COMPANY, Seoul (KR); Kia Corporation, Seoul (KR)

(72) Inventors: Sun Eui KIM, Hwaseong-si (KR); Jin Won KIM, Hwaseong-si (KR); Jun Young LIM, Hwaseong-si (KR)

(21) Appl. No.: 19/193,649

(22) Filed: Apr. 29, 2025

(30) Foreign Application Priority Data
Nov. 22, 2024 (KR) 10-2024-0168804

(51) Int. Cl. H01M 10/6561; H01M 10/613; H01M 10/647; H01M 50/209

(52) U.S. Cl. CPC H01M 10/6561; H01M 10/613; H01M 10/647; H01M 50/209

(57) ABSTRACT

A cooling member for battery cells includes a body that defines a plurality of flow paths that include a main flow path including a plurality of main flow path inlet regions defined an upper region of the body, a bypass flow path that is provided at one side of the main flow path and defines a bypass flow path inlet region defined at the upper region of the body, and a connection flow path that connects the main flow path to the bypass flow path and is disposed below the main flow path inlet regions.

### CROSS-REFERENCE TO RELATED APPLICATION

This application claims priority to and the benefit of Korean Patent Application No. 10-2024-0168804, filed in the Korean Intellectual Property Office, on Nov. 22, 2024, the entire contents of which are incorporated herein by reference.

### TECHNICAL FIELD

The present disclosure relates to a cooling member and a battery pack including the same, and more particularly, to a cooling member and a battery pack including the same, the cooling member having a flow path through which a cooling fluid can flow.

### BACKGROUND

A battery pack may include a number of batteries and a cooling device for dissipating heat generated from the battery pack. For instance, the cooling devices may be classified into water-cooled cooling devices, air-cooled cooling devices, and the like depending on the types of cooling fluids.

In some cases, a cooling cartridge may be used for the cooling device of the battery pack, and the cooling cartridge may have a flow path configured to carry cooling fluid to exchange heat with a battery cell in contact with the cartridge, thereby cooling the battery cell.

In some cases, where a temperature of the cooling fluid increases while the cooling fluid passes through the flow path in the cartridge, a cooling performance may deviate between regions of the battery cell. For instance, some battery cells may be supercooled in a region of the flow path in the cartridge that faces an upstream region, and some battery cells may not be properly cooled in a region of the flow path in the cartridge that faces a downstream region.

### SUMMARY

The present disclosure describes reduce a cooling device that can reduce a cooling deviation between regions of a battery cell in a battery pack.

According to one aspect of the subject matter described in this application, a cooling member for one or more battery cells includes a body that defines a plurality of flow paths, where the plurality of flow paths includes a main flow path including a plurality of main flow path inlet regions that are defined at an upper region of the body, a bypass flow path provided at one side of the main flow path, the bypass flow path including a bypass flow path inlet region defined at the upper region of the body, and a connection flow path that connects the main flow path and the bypass flow path to each other, the connection flow path being defined below one of the plurality of main flow path inlet regions.

Implementations according to this aspect can include one or more of the following features. For example, the plurality of main flow path inlet regions can be spaced apart from one another in a first direction, and the bypass flow path is defined at a central region of the body based on the first direction. In some examples, the main flow path is one of a plurality of main flow paths that are respectively provided at opposite sides of the bypass flow path based on the first direction.

In some implementations, the main flow path is one of a plurality of main flow paths that include a plurality of upper main flow paths that are fluidly connected to the plurality of main flow path inlet regions, respectively, and a plurality of lower main flow paths that are fluidly connected to the plurality of upper main flow paths and that are fluidly connected to a plurality of main flow path outlet regions defined at a lower region of the body. Each of the plurality of upper main flow paths can be fluidly connected to one or more of the plurality of lower main flow paths. In some examples, the plurality of upper main flow paths is fluidly connected to the plurality of lower main flow paths, respectively.

In some implementations, two upper main flow paths among at least a portion of the plurality of upper main flow paths can be disposed adjacent to each other in the first direction and fluidly connected to one of the plurality of lower main flow paths. In some implementations, the plurality of upper main flow paths include plural pairs of upper main flow paths, each pair of upper main flow paths being disposed adjacent to each other in the first direction and fluidly connected to one of the plurality of lower main flow paths.

In some examples, a flow path center line of at least one of the plurality of lower main flow paths is offset from a flow path center line of at least one of the plurality of upper main flow paths in the first direction. In some examples, flow path center lines of the plurality of lower main flow paths are offset from flow path center lines of the plurality of upper main flow paths in the first direction, respectively. In some examples, the plurality of main flow paths can further include a main connection flow passage that connects one of the plurality of upper main flow paths to one of the plurality of lower main flow paths, where the main connection flow passage extends downward in an inclined with respect to the first direction.

In some implementations, the connection flow path can be defined above the main connection flow passage. In some examples, widths of the plurality of upper main flow paths in the first direction decrease as a distance from the bypass flow path decreases in the first direction. In some examples, widths of the plurality of lower main flow paths in the first direction decrease as a distance from the bypass flow path decreases in the first direction.

In some implementations, the bypass flow path can have a bypass flow path outlet region that is defined at a lower end thereof and be in direct fluid communication with the connection flow path. In some examples, the plurality of lower main flow paths can include a first lower extension flow path portion that extends in a second direction orthogonal to the first direction, and a second lower extension flow path portion that extends from a lower end of the first lower extension flow path portion and is fluidly connected to one of the plurality of main flow path outlet regions, where the second lower extension flow path portion extends downward toward the bypass flow path in an inclined direction with respect to the first direction.

In some examples, a width of each of the plurality of main flow path inlet regions in the first direction is larger than a width of the bypass flow path inlet region in the first direction. In some examples, widths of the plurality of main flow path inlet regions in the first direction decrease as a distance from the bypass flow path inlet region decreases in the first direction. In some implementations, the main flow path extends in a second direction orthogonal to the first direction, where a width of the bypass flow path inlet region in a third direction orthogonal to the first and second directions is larger than a width of each of the plurality of main flow path inlet regions in the third direction.

According to another aspect, a battery pack includes the cooling member described above and a plurality of battery cells that are provided at one side of the body, where the plurality of battery cells include a first battery cell and a second battery cell that are spaced apart from each other in a first direction. The main flow path extends in a second direction orthogonal to the first direction, and the plurality of battery cells face the one side of the body in a third direction orthogonal to the first and second directions.

Implementations according to this aspect can include one or more of the following features or the features described above. For example, the plurality of main flow path inlet regions are spaced apart from one another in the first direction, where the bypass flow path is spaced apart from the first battery cell and the second battery cell in the first direction.

In some implementation, it can be possible to reduce a cooling deviation between the regions of the battery cell in the battery pack.

### BRIEF DESCRIPTION OF THE DRAWINGS

FIG. 1 is a front view illustrating an example of a cooling member.

FIG. 2 is an enlarged view illustrating an example of a bypass flow path of the cooling member.

FIG. 3 is a top plan view illustrating an example of a cooling flow path.

FIG. 4 is a front view illustrating an example of an arrangement structure in which the cooling member and a battery cell provided in a battery pack are disposed.

FIG. 5 is a view illustrating an example of a schematic structure of the battery pack.

### DETAILED DESCRIPTION

Hereinafter, a cooling member and a battery pack including the same will be described with reference to the drawings.

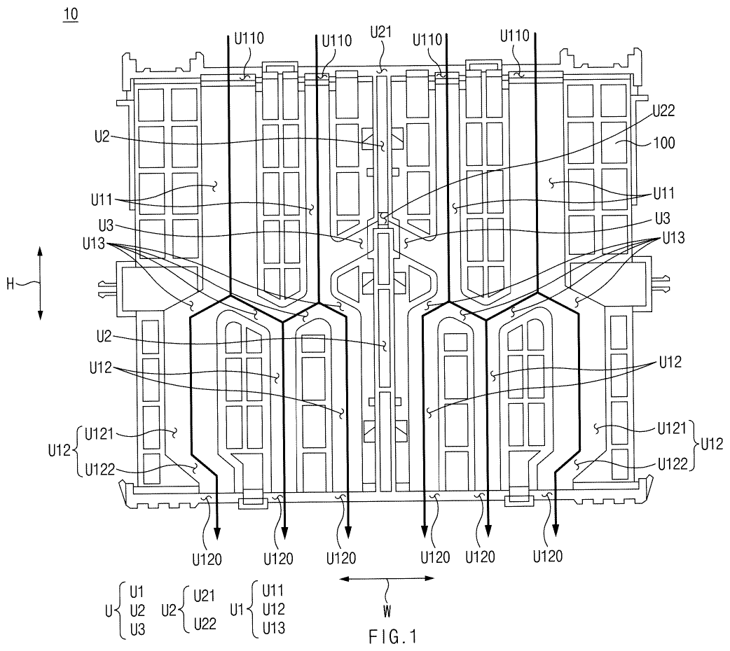

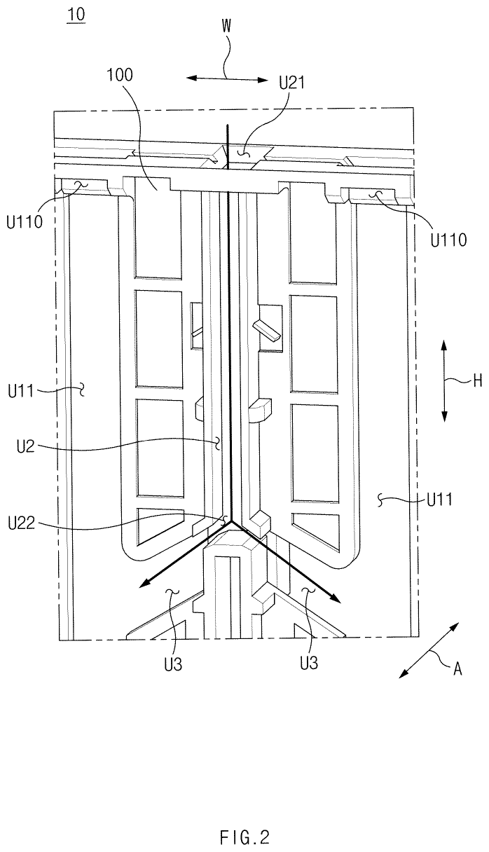

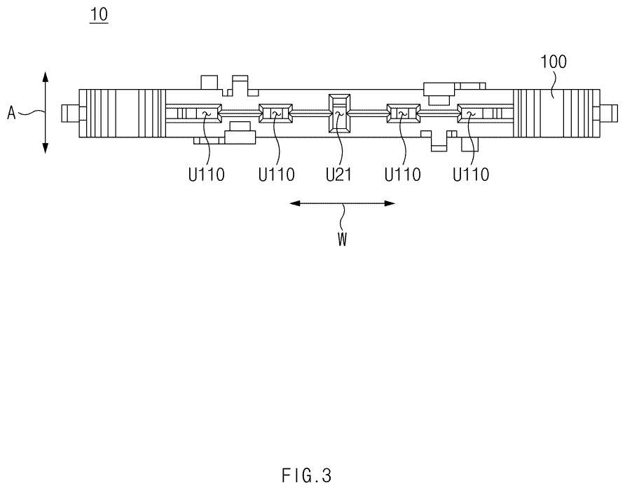

FIG. 1 is a front view illustrating an example of a cooling member, and FIG. 2 is an enlarged view illustrating an example of a bypass flow path of the cooling member. FIG. 3 is a top plan view illustrating an example of a cooling flow path.

The cooling member can be configured to cool a battery cell provided in a battery pack or the like. More specifically, a flow path can be formed in the cooling member, and a cooling fluid (e.g., air or a coolant) can flow through the flow path and cool the battery cell while exchanging heat with the battery cell.

As illustrated in FIGS. 1 to 3, a cooling member 10 can include a body 100 having therein a flow path space U.

The flow path space U can include a main flow path U1 including a plurality of main flow path inlet regions U110 formed in an upper region of the body 100, a bypass flow path U2 provided at one side of the main flow path U1 and including a bypass flow path inlet region U21 formed in the upper region of the body 100, and a connection flow path U3 configured to connect the main flow path U1 and the bypass flow path U2. The main flow path inlet region U110 and the bypass flow path inlet region U21 can each serve as an inlet through which the above-mentioned cooling fluid is introduced.

In some implementations, an upward/downward direction H, a leftward/rightward direction W, and a forward/rearward direction A (i.e., a direction passing through the surface of the page in FIG. 1) are defined based on an arrangement structure of the cooling member illustrated in FIG. 1. However, in the present specification, the upward/downward direction H, the leftward/rightward direction W, and the forward/rearward direction A can be respectively referred to as a first direction, a second direction, and a third direction.

As illustrated in FIGS. 1 and 2, in some implementations, the connection flow path U3 can be formed below the main flow path inlet region U110.

In some implementations, in case that the cooling member 10 is mounted in the battery pack, the cooling fluid, which passes through the main flow path U1 in the body 100 of the cooling member, exchanges heat with the battery cell, whereas the cooling fluid, which passes through the bypass flow path U2 of the body 100, may not exchange heat with the battery cell. However, the cooling fluid, which passes through the bypass flow path U2, can be introduced into the main flow path U1 through the connection flow path U3, and the cooling fluid, which is introduced into the main flow path U1 through the connection flow path U3, can cool the battery cell together with the cooling fluid introduced into the main flow path U1 through the main flow path inlet region U110.

In some implementations, because the bypass flow path U2 is formed in the cooling member 10, it is possible to uniformize the cooling efficiency of the regions of the cooling member 10. That is, because the cooling fluid introduced into the main flow path U1 through the main flow path inlet region U110 is in a relatively low-temperature state, the cooling fluid can cool the battery cell to a large degree while passing through the upper region of the body 100. However, because the cooling fluid introduced into a lower region through the upper region of the body 100 is in a relatively high-temperature state, the cooling fluid can cool the battery cell to a small degree.

In some implementations, because a part of the cooling fluid introduced into the cooling member 10 is introduced into the bypass flow path U2 through the bypass flow path inlet region U21 instead of the main flow path inlet region U110, the cooling fluid is not involved in cooling the battery cell during the process in which the cooling fluid passes through the upper region of the body 100. In some examples, the cooling fluid passing through the bypass flow path U2 is merged into the main flow path U1 through the connection flow path U3 and involved in cooling the battery cell in the lower region of the body 100. Therefore, it can be possible to remarkably reduce a cooling deviation between the regions based on the upward/downward direction of the cooling member 10.

In some implementations, when a direction in which the plurality of main flow path inlet regions U110 are spaced apart from one another is defined as the leftward/rightward direction W, the bypass flow path U2 can be formed in a central region of the body 100 based on the leftward/rightward direction W. For example, as illustrated in FIG. 1, the flow path space U can have a vertically symmetric shape as a whole with respect to the bypass flow path U2, and the main flow paths U1 can be respectively provided at two opposite sides of the bypass flow path U2 based on the leftward/rightward direction W.

In some examples, the main flow path U1 can be divided into a plurality of regions. More specifically, the main flow path U1 can include a plurality of upper main flow paths U11 configured to respectively communicate with the plurality of main flow path inlet regions U110, and a plurality of lower main flow paths U12 configured to communicate with the upper main flow paths U11 and communicate with main flow path outlet regions U120 formed in the lower region of the body 100.

In some examples, at least some of the plurality of upper main flow paths U11 can communicate with the plurality of lower main flow paths U12. It can be understood that the flow path branches off from a region in which the upper main flow paths U11 and the lower main flow paths U12 meet together. More particularly, the plurality of upper main flow paths U11 can respectively communicate with the plurality of lower main flow paths U12. For example, FIG. 1 illustrates a state in which the plurality of upper main flow paths U11 communicate with the two lower main flow paths U12.

In some implementations, among at least some of the plurality of upper main flow paths U11, the two upper main flow paths U11, which are adjacent to each other in the leftward/rightward direction W, can communicate with the lower main flow paths U12. More particularly, among the plurality of upper main flow paths U11, the two upper main flow paths U11, which are adjacent to each other in the leftward/rightward direction W, can communicate with the same lower main flow path U12. For example, FIG. 1 illustrates a state in which the remaining lower main flow paths U12, which exclude the lower main flow paths U12 provided at outermost sides based on the leftward/rightward direction W among the plurality of lower main flow paths U12, communicate with the two adjacent upper main flow paths U11. In some examples, the plurality of upper main flow paths U11 include a left pair of upper main flow paths U11 disposed at a left side of the bypath flow path U2 and a right pair of upper main flow paths U11 disposed at a right side of the bypath flow path US, each pair of upper main flow paths being disposed adjacent to each other in the first direction and fluidly connected to one common path among the plurality of lower main flow paths U12.

In some examples, flow path centers of at least some of the plurality of lower main flow paths U12 based on the leftward/rightward direction W can be spaced apart, in the leftward/rightward direction W, from flow path centers of the plurality of upper main flow paths U11 based on the leftward/rightward direction W. More particularly, the flow path centers of the plurality of lower main flow paths U12 based on the leftward/rightward direction W can be respectively spaced apart, in the leftward/rightward direction W, from the flow path centers of the plurality of upper main flow paths U11 based on the leftward/rightward direction W. It can be understood that a region in which the upper main flow path U11 and the lower main flow path U12 are connected to each other extends inclinedly. More specifically, the main flow path U1 can further include main connection flow passages U13 configured to connect the upper main flow paths U11 and the lower main flow paths U12, and the main connection flow passages U13 can extend to be inclined in the leftward/rightward direction W and the downward direction.

In some implementations, the cooling fluid in the bypass flow path U2 is not involved in cooling the battery cell in the upper region of the cooling member 10, and the cooling fluid in the bypass flow path U2 can be involved in cooling the battery cell in the lower region of the cooling member 10 as the cooling fluid is introduced into the main flow path U1. In some examples, the cooling fluid flowing through the bypass flow path U2 can reach an upper end region of the lower main flow path U12 through the connection flow path U3.

For example, as illustrated in FIGS. 1 and 2, the connection flow path U3 can be formed above the main connection flow passage U13. Therefore, the cooling fluid introduced into the main flow path U1 through the connection flow path U3 can be introduced into the lower main flow path U12 through the main connection flow passage U13.

In some implementations, at least some of the plurality of upper main flow paths U11 can be different in width from the other upper main flow paths U11. More specifically, the widths of the plurality of upper main flow paths U11 in the leftward/rightward direction W can decrease as the distance from the bypass flow path U2 decreases in the leftward/rightward direction W. In addition, at least some of the plurality of lower main flow paths U12 can be different in width from the other lower main flow paths U12. More specifically, the widths of the plurality of lower main flow paths U12 in the leftward/rightward direction W can decrease as the distance from the bypass flow path U2 decreases in the leftward/rightward direction W. This configuration can be implemented in consideration of a situation in which the cooling fluid discharged from the bypass flow path U2 can be supplied to the lower main flow path U12, which is adjacent to the bypass flow path U2 in the leftward/rightward direction W, whereas no or almost no cooling fluid discharged from the bypass flow path U2 can be supplied to the lower main flow path U12 spaced apart from the bypass flow path U2 in the leftward/rightward direction W.

In some implementations, a bypass flow path outlet region U22 formed at a lower end of the bypass flow path U2 can communicate directly with the connection flow path U3. It can be understood that the bypass flow path U2 does not extend to the lower region of the cooling member 10. That is, a length of the bypass flow path U2 in the upward/downward direction H can be shorter than a length of the main flow path U1 in the upward/downward direction H. Therefore, the entire fluid passing through the bypass flow path U2 can be supplied to the main flow path U1 through the connection flow path U3.

In some implementations, at least some of the plurality of lower main flow paths U1 can each have a bent shape instead of a straight shape. More specifically, as illustrated in FIG. 1, at least some of the plurality of lower main flow paths U12 can each include a first lower extension flow path portion U121 extending in a direction parallel to the upward/downward direction H, and a second lower extension flow path portion U122 extending from a lower end of the first lower extension flow path portion U121 and configured to communicate with the main flow path outlet region U120. In this case, the second lower extension flow path portion U122 can extend to be inclined inward in the downward direction and the leftward/rightward direction toward the bypass flow path U2 in the leftward/rightward direction W. FIG. 1 illustrates a state in which the lower main flow paths U1, which are formed at the outermost sides of the body 100 based on the leftward/rightward direction W among the plurality of lower main flow paths U1, each include the first lower extension flow path portion U121 and the second lower extension flow path portion U122, and the remaining lower main flow paths U1 each have a straight shape.

In some implementations, with reference to FIG. 3, a width of each of the plurality of main flow path inlet regions U110 can be different from a width of each of the bypass flow path inlet region U21. More specifically, a width of each of the plurality of main flow path inlet regions U110 in the leftward/rightward direction W can be larger than a width of the bypass flow path inlet region U21 in the leftward/rightward direction W. In some examples, a width of the bypass flow path inlet region U21 in the forward/rearward direction A can be larger than a width of each of the plurality of main flow path inlet regions U110 in the forward/rearward direction A. This can be to ensure a predetermined flow rate of the cooling fluid passing through the bypass flow path U2 while preventing the cooling fluid, which passes through the bypass flow path U2, from affecting the cooling of the battery cell by allowing the bypass flow path U2 to have a relatively small width in the leftward/rightward direction W. In some implementations, with continued reference to FIG. 3, the widths of the plurality of main flow path inlet regions U110 in the leftward/rightward direction W can decrease as the distance from the bypass flow path inlet region U21 decreases in the leftward/rightward direction W.

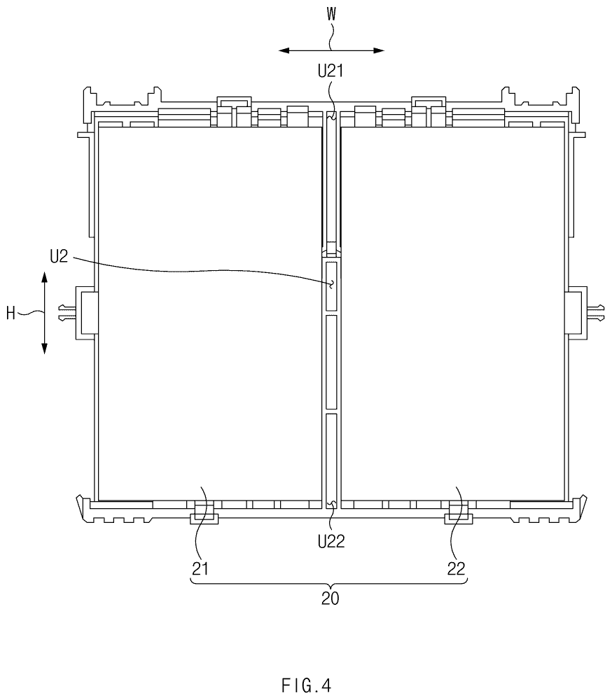

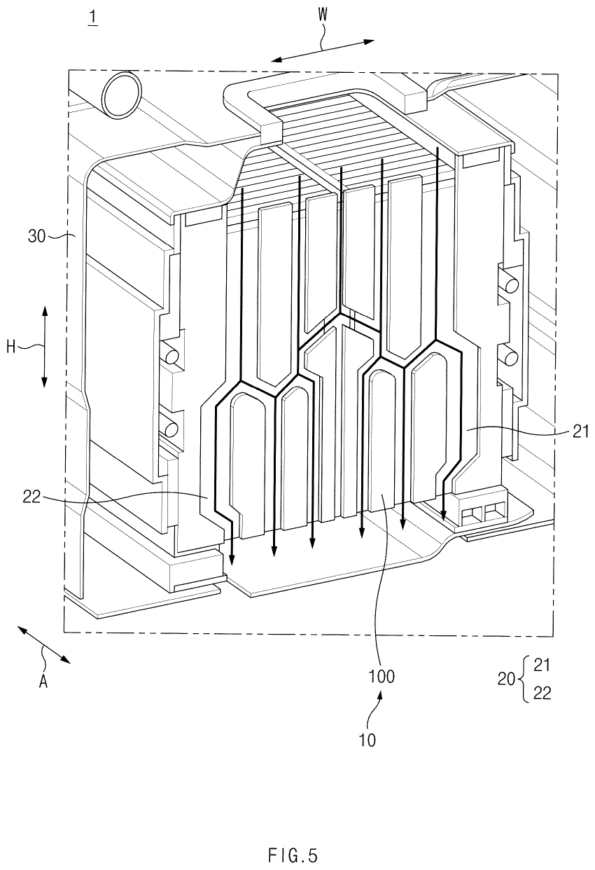

FIG. 4 is a front view illustrating an arrangement structure in which the cooling member and the battery cell provided in the battery pack are disposed, and FIG. 5 is a view illustrating a schematic structure of the battery pack of the present disclosure.

With reference to FIGS. 4 and 5, a battery pack 1 can include the cooling member 10, and a battery cell 20 provided at one side of the cooling member 10 based on the forward/rearward direction A. The description of the cooling member provided in the battery pack is replaced with the description of the cooling member described above with reference to FIGS. 1 to 3.

In some implementations, more particularly, the battery cell 20 can be in contact with one side surface of the cooling member 10 based on the forward/rearward direction A. In addition, the battery cell 20 can include a first battery cell 21, and a second battery cell 22 spaced apart from the first battery cell 21 in the leftward/rightward direction W. In addition, the battery cell provided in the battery pack can be an angular cell. Alternatively, the battery cell can be other types of battery cells such as a pouch-type cell.

In some implementations, when the direction in which the plurality of main flow path inlet regions U110 are spaced apart from one another is defined as the leftward/rightward direction W, the bypass flow path U2 formed in the body 100 of the cooling member 10 can be spaced apart from the first battery cell 21 and the second battery cell 22 in the leftward/rightward direction W. Therefore, the cooling fluid may not be involved in cooling the battery cell 20 while the cooling fluid passes through the bypass flow path U2.

The present disclosure has been described with reference to the limited implementations and the drawings, but the present disclosure is not limited thereby. The present disclosure can be carried out in various forms by those skilled in the art, to which the present disclosure pertains, within the technical spirit of the present disclosure and the scope equivalent to the appended claims.

What is claimed is:

1. A cooling member for one or more battery cells, the cooling member comprising:
a body that defines a plurality of flow paths, the plurality of flow paths comprising:
a main flow path comprising a plurality of main flow path inlet regions that are defined at an upper region of the body;
a bypass flow path provided at one side of the main flow path, the bypass flow path comprising a bypass flow path inlet region defined at the upper region of the body; and
a connection flow path that connects the main flow path and the bypass flow path to each other, the connection flow path being defined below one of the plurality of main flow path inlet regions.

2. The cooling member of claim 1, wherein the plurality of main flow path inlet regions are spaced apart from one another in a first direction, and
wherein the bypass flow path is defined at a central region of the body based on the first direction.

3. The cooling member of claim 2, wherein the main flow path is one of a plurality of main flow paths that are respectively provided at opposite sides of the bypass flow path based on the first direction.

4. The cooling member of claim 2, wherein the main flow path is one of a plurality of main flow paths comprising:
a plurality of upper main flow paths that are fluidly connected to the plurality of main flow path inlet regions, respectively; and
a plurality of lower main flow paths that are fluidly connected to the plurality of upper main flow paths and that are fluidly connected to a plurality of main flow path outlet regions defined at a lower region of the body, and
wherein each of the plurality of upper main flow paths is fluidly connected to one or more of the plurality of lower main flow paths.

5. The cooling member of claim 4, wherein the plurality of upper main flow paths is fluidly connected to the plurality of lower main flow paths, respectively.

6. The cooling member of claim 4, wherein two upper main flow paths among the plurality of upper main flow paths are disposed adjacent to each other in the first direction and fluidly connected to one of the plurality of lower main flow paths.

7. The cooling member of claim 4, wherein the plurality of upper main flow paths comprise plural pairs of upper main flow paths, each pair of upper main flow paths being disposed adjacent to each other in the first direction and fluidly connected to one of the plurality of lower main flow paths.

8. The cooling member of claim 4, wherein a flow path center line of at least one of the plurality of lower main flow paths is offset from a flow path center line of at least one of the plurality of upper main flow paths in the first direction.

9. The cooling member of claim 4, wherein flow path center lines of the plurality of lower main flow paths are offset from flow path center lines of the plurality of upper main flow paths in the first direction, respectively.

10. The cooling member of claim 4, wherein the plurality of main flow paths further comprise a main connection flow passage that connects one of the plurality of upper main flow paths to one of the plurality of lower main flow paths, and
wherein the main connection flow passage extends downward in an inclined with respect to the first direction.

11. The cooling member of claim 10, wherein the connection flow path is defined above the main connection flow passage.

12. The cooling member of claim 4, wherein widths of the plurality of upper main flow paths in the first direction decrease as a distance from the bypass flow path decreases in the first direction.

13. The cooling member of claim 4, wherein widths of the plurality of lower main flow paths in the first direction decrease as a distance from the bypass flow path decreases in the first direction.

14. The cooling member of claim 1, wherein the bypass flow path has a bypass flow path outlet region that is defined at a lower end thereof and is in direct fluid communication with the connection flow path.

15. The cooling member of claim 4, wherein the plurality of lower main flow paths comprise:
a first lower extension flow path portion that extends in a second direction orthogonal to the first direction; and
a second lower extension flow path portion that extends from a lower end of the first lower extension flow path portion and is fluidly connected to one of the plurality of main flow path outlet regions, and
wherein the second lower extension flow path portion extends downward toward the bypass flow path in an inclined direction with respect to the first direction.

16. The cooling member of claim 2, wherein a width of each of the plurality of main flow path inlet regions in the first direction is larger than a width of the bypass flow path inlet region in the first direction.

17. The cooling member of claim 2, wherein widths of the plurality of main flow path inlet regions in the first direction decrease as a distance from the bypass flow path inlet region decreases in the first direction.

18. The cooling member of claim 2, wherein the main flow path extends in a second direction orthogonal to the first direction, and
wherein a width of the bypass flow path inlet region in a third direction orthogonal to the first and second directions is larger than a width of each of the plurality of main flow path inlet regions in the third direction.

19. A battery pack comprising:
the cooling member according to claim 1; and
a plurality of battery cells that are provided at one side of the body, the plurality of battery cells comprising a first battery cell and a second battery cell that are spaced apart from each other in a first direction,
wherein the main flow path extends in a second direction orthogonal to the first direction, and
wherein the plurality of battery cells face the one side of the body in a third direction orthogonal to the first and second directions.

20. The battery pack of claim 19, wherein the plurality of main flow path inlet regions are spaced apart from one another in the first direction, and
wherein the bypass flow path is spaced apart from the first battery cell and the second battery cell in the first direction.
